(19) United States
(12) Patent Application Publication
(10) Pub. No.: US 2024/0327210 A1
(43) Pub. Date: Oct. 3, 2024

(54) REACTOR AND METHOD FOR PRODUCING AMMONIA DECOMPOSITION MIXTURE USING THE SAME

(71) Applicant: Toyo Engineering Corporation, Tokyo (JP)

(72) Inventor: Satoshi OKAJIMA, Chiba (JP)

(73) Assignee: Toyo Engineering Corporation, Tokyo (JP)

(21) Appl. No.: 18/579,755

(22) PCT Filed: Jul. 20, 2022
(86) PCT No.: PCT/JP2022/028211

§ 371 Date: Jan. 16, 2024

(30) Foreign Application Priority Data
Aug. 4, 2021 (JP) 2021-127870

(51) Int. Cl. C01B 3/04; B01J 8/02; B01J 23/755; B01J 35/56

(52) U.S. Cl. CPC C01B 3/047; B01J 8/025; B01J 23/755; B01J 35/56; C01B 2203/0277; C01B 2203/1058; C01B 2203/1064; C01B 2203/1082

(57) ABSTRACT

The present invention provides a radial flow reactor with less uneven temperature even when an endothermic reaction is performed, small pressure loss, and easy maintainability as well, and also provides a method for producing an ammonia decomposition mixture using the same. The reactor according to the present invention is a so-called radial flow reactor having a cylindrical reaction vessel disposed in an upright position and a reaction region inside the reaction vessel, in which a chemical reaction is performed, wherein the reaction region has a catalyst member, having a heating part that generates heat by being energized and a catalyst disposed to be heated by the heating part, which is concentrically disposed in a cross-section perpendicular to an axial direction of the reaction vessel.

### TECHNICAL FIELD

The present invention relates to a reactor suitable for an ammonia decomposition reaction and the like.

### BACKGROUND ART

An ammonia decomposition reaction is a reaction in which the number of gas molecules is increased as the reaction proceeds, and the reaction easily proceeds at a lower reaction pressure in terms of equilibrium. On the other hand, considering that a volumetric flow rate and a required reactor volume are increased as a pressure is decreased as well as that a pressure is required for the subsequent separation and purification processes, it cannot be simply said that a lower pressure is preferable.

On the contrary, a methanol synthesis reaction, for example, is a reaction in which the number of molecules is decreased as the reaction proceeds, which means a higher reaction pressure is advantageous in terms of equilibrium reaction. For this reaction, lower pressure loss than that of an ordinary cylindrical reactor is realized by using a radial flow reactor and temperature distribution in the reactor is optimized by appropriately disposing cooling tubes, to improve a conversion ratio.

Patent Document 1 discloses a reactor which is composed of a shell-and-tube heat exchanger having a shell and cooling tubes. More precisely, this reactor has a shell has: an upright cylinder, an upper tube plate configured to be outwardly and convexly curved to close an upper part of the upright cylinder, and a lower tube plate configured to be outwardly and convexly curved to close a lower part of the upright cylinder; a cylindrical permeable wall provided to face most part of inner periphery of the upright cylinder and joined to the upright cylinder at an upper and lower end; at least one outer peripheral aperture communicating an outer peripheral space between the permeable wall and the upright cylinder with an outside of the shell; a central tube provided in the center of the upright cylinder, whose upper end is closed and which has a number of holes in the area substantially corresponding to the permeable cylindrical wall to have breathability, and whose lower end penetrates through the lower tube plate and a hereinafter described lower header cover and is opened to an outside of the shell; and a number of cooling tubes, whose upper and lower ends connect to the upper tube plate and the lower tube plate, respectively, to communicate and to be opened outside of the shell; wherein the shell at least corresponding to permeable portions of a permeable inner wall is filled with a catalyst.

Patent Document 2 discloses a reactor in a cylindrical reaction vessel disposed in an upright position, which has: a filling region which is an area accommodating a continuous packed bed of granular filling material; and an outer flow channel and an inner flow channel disposed outside and inside the filling region, respectively, in a cross-section perpendicular to an axial direction of the reaction vessel, in which fluid can flow in the axial direction; wherein the reactor is configured to allow fluid to flow between the filling region and the outer flow channel as well as between the filling region and the inner flow channel. The reactor has at least one of partition structures, which include: an outer partition structure including a partition plate which axially partitions the filling region ensuring a gap with an inner edge of the filling region through which granular fillings can pass and a blocking part that blocks axial fluid flow in the outer flow channel, and an inner partition structure including a partition plate which axially partitions the filling region ensuring a gap with an outer edge of the filling region through which granular fillings can pass and a blocking part that blocks the axial fluid flow in the inner flow channel. Such reactors, as described in Non-Patent Document 1, are in practical use in the name of MRF-Z (registered trademark) reactors.

In the meanwhile, Patent Document 3 discloses a catalytic reaction system using a catalyst to promote chemical reactions of treated fluid. This catalytic reaction system has a chamber through which the treated fluid flows, a catalyst member disposed in the chamber to be contacted with the treated fluid, and a control device supplying electric power to the catalyst member; wherein the catalyst member has a plurality of catalytic bodies disposed in multiple stages along the flow direction of the treated fluid; wherein each of the catalytic bodies has a heating part generating heat by being energized and a carrier supporting a catalytic substance disposed on the surface of the heating part; and wherein the control device controls a temperature of each of the catalytic bodies independently of each other.

### PRIOR ART DOCUMENTS

### Patent Documents

Patent Document 1: JP 04-180827 A
Patent Document 2: JP 2011-206648 A
Patent Document 3: JP 2015-98408 A

### Non-Patent Document

Non-Patent Document 1: https://www.toyo-eng.com/jp/ja/products/petrochmical/metha nol

### SUMMARY OF THE INVENTION

### Problem to be Solved by the Invention

In an ammonia decomposition reaction, a reaction in the reactor is also expected to be optimized by using a radial flow reactor as seen in Patent Documents 1 and 2 to achieve a lower pressure loss than that in a catalyst packed bed in an ordinary cylindrical reactor and the like and to control heat input. Furthermore, flowing from inside to outside to the contrary to a methanol synthesis reaction is expected to result in a decrease of the flow velocity as it passes through the reactor and a decrease of the dynamic pressure to advantageously perform a decomposition reaction in terms of equilibrium.

However, when an ammonia decomposition reaction is performed using the reactor in Patent Documents 1 and 2, it is necessary to heat ammonia in an external furnace or heat exchanger before supplying it because the decomposition reaction of ammonia is an endothermic reaction. Nonetheless, there have been times when temperatures go uneven and efficiency is reduced depending on the flow of fluid in the reactor. Furthermore, even if the flow of fluid in the reactor can be controlled, a temperature difference between an upstream side and a downstream side of the reactor results in excessive heating in some places, leading to accelerating the deterioration of the catalyst, in an attempt to control a reaction temperature in the entire reactor. Although the reactor in Patent Document 3 can control upstream and downstream temperatures in the reactor to be different from each other, the pressure loss of catalyst layers is large and it is expected that arranging necessary wires and temperature sensors for each catalyst layer on a side of the reactor makes maintenance work including replacing them difficult. In particular, it has been considered difficult to boost the size of a reactor.

The purpose of the present invention is to provide a radial flow reactor with less uneven temperature even when an endothermic reaction is performed, small pressure loss, and easy maintainability as well, and also to provide a method for producing an ammonia decomposition mixture using the same.

### Means of Solving the Problem

The present invention is a reactor, comprising:
a cylindrical reaction vessel disposed in an upright position, and
a reaction region inside of the reaction vessel, in which a chemical reaction is performed;
wherein the reaction region has a catalyst member, having a heating part generating heat by being energized and a catalyst disposed to be heated by the heating part, which is concentrically disposed in a cross-section perpendicular to an axial direction of the reaction vessel; and
wherein the reaction vessel comprises:
   an outer flow channel which is formed on an outer side relative to the reaction region in a cross-section perpendicular to the axial direction of the reaction vessel and which is communicated with an outside of the reaction vessel,
   a central flow channel which is formed on a center side relative to the reaction region in a cross-section perpendicular to the axial direction of the reaction vessel and which is communicated with an outside of the reaction vessel,
   an outer flow channel wall separating the reaction region and the outer flow channel, through which fluid can pass, and
   a central flow channel wall separating the reaction region and the central flow channel, through which fluid can pass.

The present invention is a method for producing an ammonia decomposition mixture by a decomposition reaction of ammonia using the above-mentioned reactor, comprising:
introducing ammonia from the central flow channel into the reaction region,
energizing the heating part to heat the catalyst,
performing a decomposition reaction of ammonia in the reaction region to produce an ammonia decomposition mixture, and
discharging the ammonia decomposition mixture from the reaction region to the outer flow channel.

### Effects of the Invention

The present invention can provide a radial flow reactor with less uneven temperature even when an endothermic reaction is performed, small pressure loss, and easy maintainability as well, and can also provide a method for producing an ammonia decomposition mixture using the same.

### BRIEF DESCRIPTION OF THE DRAWINGS

FIG. 1 is a schematic vertical cross-sectional view illustrating a configuration example of a reactor according to the present invention.

FIG. 2 is a schematic horizontal cross-sectional view illustrating a configuration example of a reactor according to the present invention.

FIG. 3 is a schematic view illustrating a surface structure of an outer flow channel wall or a central flow channel wall, where holes are formed on the surface in (a) and slits are formed on the surface in (b).

FIG. 4 is a schematic perspective view illustrating a configuration example of a catalyst-supported wire.

FIG. 5 is a schematic plan view illustrating a configuration example of a catalyst member using a catalyst-supported wire.

### MODE FOR CARRYING OUT THE INVENTION

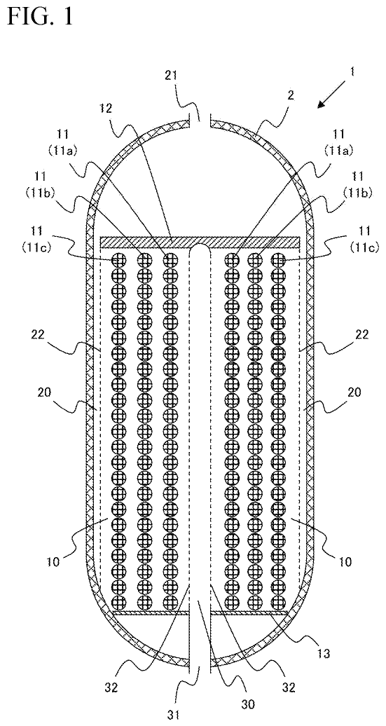

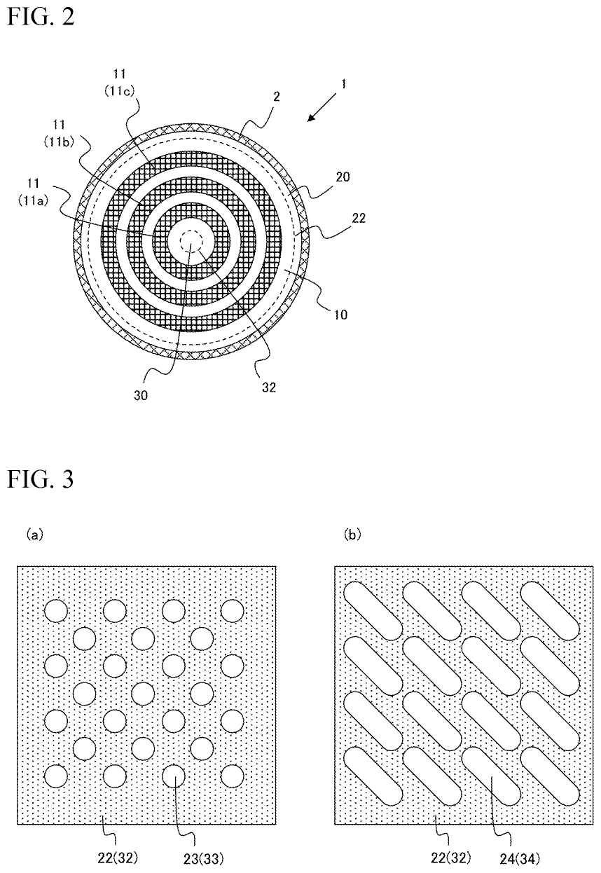

FIG. 1 (vertical cross-sectional view) and FIG. 2 (horizontal cross-sectional view) illustrate a configuration example of a reactor according to the present invention. A reactor 1 according to the present invention is a so-called radial flow reactor, having a reaction vessel 2 which is disposed in an upright position and at least a center of which is cylindrical, and a reaction region 10 inside the reaction vessel 2, in which a chemical reaction is performed. Inside the reaction vessel 2, an outer flow channel 20 is formed on an outer side relative to the reaction region 10, and a central flow channel 30 is formed on a center side relative to the reaction region 10, in a cross-section perpendicular to an axial direction of the cylindrical reaction vessel 2.

An outer flow channel wall 22 is disposed at a boundary between the reaction region 10 and the outer flow channel 20. In other words, the outer flow channel wall 22 separates the reaction region 10 and the outer flow channel 20, and the outer flow channel 20 is an outer area of the outer flow channel wall 22 in a cross-section perpendicular to the axial direction of the reaction vessel 2. A hole 23 or a slit 24, which penetrates through front and back surfaces of the outer flow channel wall 22 and through which fluid can pass, is formed on the outer flow channel wall 22, as shown in FIG. 3, for example. This enables fluid to pass from the reaction region 10 to the outer flow channel 20, or from the outer flow channel 20 to the reaction region 10.

The outer flow channel wall 22 has a cylindrical shape, for example, and is disposed concentrically in a cross-section perpendicular to the axial direction of the reaction vessel 2. As shown in FIG. 1, for example, a lower part of the outer flow channel wall 22 is connected to a lower part of the reaction vessel 2, and an upper part of the outer flow channel wall 22 is connected to an outer edge of a disk-shaped upper plate 12. The outer flow channel 20, separated by the outer flow channel wall 22, is sometimes referred to as “outer shell” or “outer basket” because it is formed on an outer edge of the cylindrical reaction vessel 2. In addition, the outer flow channel 20 formed on an outside of the outer flow channel wall 22 communicates with an outside of the reaction vessel 2 through a communicating passage 21 for the outer flow channel formed on an upper part of the reaction vessel 2, as shown in FIG. 1, for example.

A central flow channel wall 32 is disposed at a boundary between the reaction region 10 and the central flow channel 30. In other words, the central flow channel wall 32 separates the reaction region 10 and the central flow channel 30, and the central flow channel 30 is a central (inner) area of the central flow channel wall 32 in a cross-section perpendicular to the axial direction of the reaction vessel 2. A hole 33 or a slit 34, which penetrates through front and back surfaces of the central flow channel wall 32 and through which fluid can pass, is formed on the central flow channel wall 32, as shown in FIG. 3, for example. This enables fluid to pass from the reaction region 10 to the central flow channel 30, or from the central flow channel 30 to the reaction region 10.

The central flow channel wall 32 has a pipy shape, for example, and is disposed along the central axis of the reaction vessel 2. As shown in FIG. 1, for example, an upper part of the central flow channel wall 32 is closed, and a lower part of the central flow channel wall 32 penetrates through the reaction vessel 2. The central flow channel 30, separated by the central flow channel wall 32, is sometimes referred to as “center pipe” because it is formed in a pipy shape at the center of the inside of the cylindrical reaction vessel 2. In addition, the central flow channel 30 formed on a center side (inside) of the central flow channel wall 32 communicates with an outside of the reaction vessel 2 through a communicating passage 31 for the central flow channel which is a lower end of the pipy central flow channel wall 32 penetrating through a lower part of the reaction vessel 2, as shown in FIG. 1, for example.

With the reactor 1 as described above, fluid (reaction raw material) introduced into the reaction vessel 2 flows in a radial direction in a cross-section perpendicular to the axial direction of the reaction vessel 2, which enables at least a part of the reaction raw material to be reacted in the reaction region 10. More specifically, fluid (reaction raw material) supplied into the reaction vessel 2 from the communicating passage 31 for the central flow channel flows through the central flow channel 30, passes through the central flow channel wall 32, and is introduced into the reaction region 10. After at least a part of the fluid (reaction raw material) is reacted in the reaction region 10, fluid (reaction mixture) passes through the outer flow channel wall 22, flows through the outer flow channel 20, and is discharged outside from the communicating passage 21 for the outer flow channel. Alternatively, fluid (reaction raw material) supplied into the reaction vessel 2 from the communicating passage 21 for the outer flow channel flows through the outer flow channel 20, passes through the outer flow channel wall 22, and is introduced into the reaction region 10. After at least a part of the fluid (reaction raw material) is reacted in the reaction region 10, fluid (reaction mixture) passes through the central flow channel wall 32, flows through the central flow channel 30, and is discharged outside from the communicating passage 31 for the central flow channel.

In the reaction region 10, a catalyst for reacting reaction raw material is typically disposed. In a typical radial flow reactor, the reaction region 10 is often filled with granular catalysts. However, in an endothermic reaction, for example, it is necessary to maintain the temperature of the reaction region 10 because the temperature is dropped as the reaction proceeds. Conventionally, methods such as heating up reaction raw material by a furnace or heat exchanger before introducing it or passing a tube-type pipe through the reaction region 10 and flowing a heat medium through the pipe to heat the reaction region 10, have been adopted. However, these methods tend to bring uneven temperature in the reaction region 10, which has sometimes resulted in decreasing efficiency. In addition, since a reaction proceeds while fluid flows in a radial direction in a cross-section perpendicular to the axial direction of the reaction vessel 2, a concentration of the reaction raw material may vary depending on the radial position of the reaction region 10, which means an optimum temperature may differ. Furthermore, although heat media such as steam and combustion exhaust gas and the like are generally used as a source of heat, these emit carbon dioxide as they are mainly generated by combusting fossil fuels. Electricity is sometimes used to generate a heat medium, but efficiency is low because it heats up indirectly.

Hence, in the reaction region 10 of the reactor 1 according to the present invention, a catalyst member 11 capable of heating a catalyst with a heating part that generates heat by being energized is concentrically disposed in a cross-section perpendicular to the axial direction of the reaction vessel 2. This configuration makes it possible to directly heat a catalyst by energizing the heating part, which enables quick start and stop of a reaction, less uneven temperature, and small pressure loss compared to a conventional catalytic packed-bed reactor, and also provides an optimum temperature distribution for the reaction. The catalyst member 11 is preferably formed in a cylindrical shape as it is concentrically disposed in a cross-section perpendicular to the axial direction of the reaction vessel 2. The cylindrical catalyst member 11 can be directly disposed on a bottom of the reaction region 1 or on a bottom plate 13 installed at a bottom part. Furthermore, using electricity derived from renewable energy as electricity for a source of heat can suppress carbon dioxide generation.

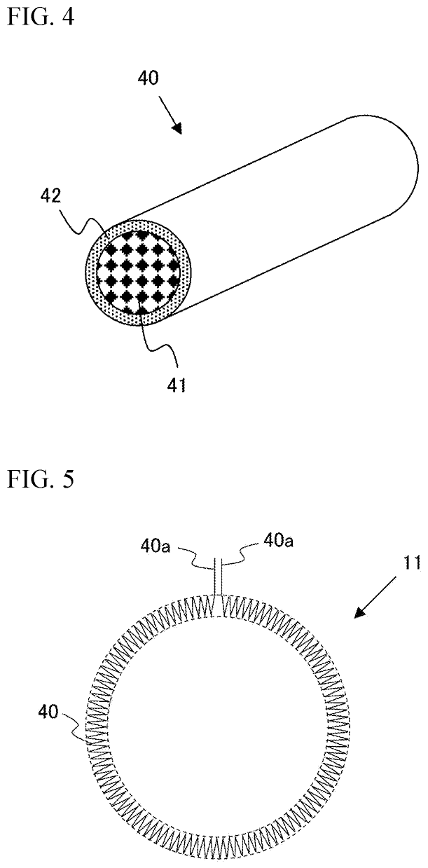

The catalyst member 11 only needs a heating part generating heat by being energized and a catalyst disposed to be heated by the heating part. However, as shown in FIG. 4, for example, it can be formed of a catalyst-supported wire 40, which has a wire-shaped electric heating wire 41 as the heating part and a catalyst layer 42 containing the catalyst and disposed on a surface of the electric heating wire 41. The wire-shaped electric heating wire 41 may be composed of a single wire or a bundle of multiple wires. The catalyst layer 42 may have, for example, a carrier and a catalyst supported by the carrier.

For a material constituting a heating part (e.g., electric heating wire 41), a material having electrical properties capable of self-heating to a predetermined temperature by being energized is suitable. For example, at least one metal selected from the group consisting of copper, magnesium, calcium, nickel, cobalt, vanadium, niobium, chromium, titanium, aluminum, silicon, molybdenum, tungsten, and iron, or an alloy thereof is selected.

A carrier may be appropriately selected from materials capable of supporting a catalyst. Examples thereof include, for example, silicon oxide (SiO₂, silica), aluminum oxide (Al₂O₃, alumina), titanium oxide (TiO₂, titania), magnesium oxide (MgO), calcium oxide (CaO), cesium oxide (Cs₂O), praseodymium oxide (Pr₆O₁₁), lanthanum oxide (La₂O₃), and activated carbon. Composite materials containing these materials can also be used. Among these, alumina is preferable, and γ-alumina is more preferable in terms of fabrication.

The catalyst supported by the carrier may be appropriately selected from catalysts that accelerate the progress of a reaction performed in the reaction region 10. Examples thereof include, for example, iron (Fe), cobalt (Co), nickel (Ni), ruthenium (Ru), rhodium (Rh), palladium (Pd), osmium (Os), iridium (Ir), platinum (Pt), and gold (Au). Composite materials containing these materials can also be used. Among these, ruthenium or nickel is preferable.

The cylindrical catalyst member 11 using a catalyst-supported wire 40 can be formed, as shown in FIG. 5, for example, by winding the catalyst-supported wire 40 into a helix or mesh (multiple helices) to form a doughnut shape as a whole, stacking them up in multiple layers, and connecting end portions 40a of each catalyst-supported wire 40 to one another. The cylindrical catalyst member 11 can also be formed by winding the catalyst-supported wire 40 into a helix or mesh and further winding it in total into a helix or mesh.

In addition, as shown in FIGS. 1 and 2, a plurality of the catalyst members 11 (11a, 11b, 11c) may be concentrically disposed in a cross-section perpendicular to the axial direction of the reaction vessel 2 in the reaction region 10. Making amounts of current passing through the plurality of catalyst members 11 (11a, 11b, 11c) each independently controllable allows controlling each catalyst to be at an optimal temperature depending on a radial position of the reaction region 10. The number of the catalyst member 11 disposed in the reaction region 10 is preferably from 1 to 6 and more preferably from 2 to 4. Moreover, an electric wire (not shown) for applying electric current to the catalyst member 11 and a temperature sensor (not shown) for detecting the temperature of the catalyst member 11 can be intensively disposed at a bottom or top of the reactor 1 to facilitate inspections and replacements of the catalyst member, the wire, and the temperature sensor.

Examples of the reaction performed in the reactor 1 according to the present invention include, for example, endothermic decomposition reactions in a gas phase, especially reactions for producing hydrogen, such as ammonia decomposition reactions, hydrocarbon steam-reforming reactions, methanol decomposition reactions, and organic hydrides dehydrogenation reactions. Among these, an ammonia decomposition reaction is preferable. Since these reactions are endothermic reactions and heating with less uneven temperature and temperature control are very important, the reactor 1 according to the present invention is suitably used.

An embodiment of an ammonia decomposition reaction (production of an ammonia decomposition mixture) using the reactor 1 according to the present invention is described as follows. An ammonia decomposition reaction proceeds according to the following reaction formula, in the presence of a ruthenium or nickel catalyst.

2NH₃→N₂+3H₂

Since this reaction is an endothermic reaction, heating with less uneven temperature and temperature control is very important to promote the reaction efficiently. In addition, this is a reaction where the number of gas molecules is increased as the reaction proceeds.

From this perspective, for performing an ammonia decomposition reaction using the reactor 1 according to the present invention, it is preferable to introduce ammonia from the central flow channel 30 and to discharge an ammonia decomposition mixture into the outer flow channel 20. By this embodiment, a reaction raw material is transferred from a central side to an outer side of the reaction region 10, which is considered advantageous in terms of a reaction equilibrium because flow velocity and dynamic pressure are decreased as the reaction proceeds.

More specifically, ammonia as a reaction raw material is first introduced from the communicating passage 31 for the central flow channel into the central flow channel 30. Ammonia introduced into the central flow channel 30 flows in the central flow channel 30 and is introduced from the central flow channel 30 into the reaction region 10 through the central flow channel wall 32. A catalyst in the catalyst member 11 disposed in the reaction region 10 is heated by applying electrical current to a heating part of the catalyst member 11. By this, a decomposition reaction of the ammonia introduced in the reaction region 10 is performed to produce an ammonia decomposition mixture. The ammonia decomposition mixture produced in the reaction region 10 is discharged from the reaction region 10 into the outer flow channel 20 through the outer flow channel wall 22, flows in the outer flow channel 20, and is discharged outside from the communicating passage 21 for the outer flow channel.

A temperature of the heating part of the catalyst member 11 may be set according to the concentration of the ammonia and the type of the catalyst and the like, but is preferably from 350 to 700° C. and more preferably from 400 to 650 C. A pressure of the reaction region 10 may be set according to the concentration of the ammonia and the type of the catalyst and the like, but is preferably from 0 to 0.9 MPaG.

### DESCRIPTION OF NUMERALS

1 Reactor
2 Reaction vessel
10 Reaction region
11 Catalyst member
12 Upper plate
13 Bottom plate
20 Outer flow channel
21 Communicating passage for outer flow channel
22 Outer flow channel wall
23 Hole
24 Slit
30 Central flow channel
31 Communicating passage for central flow channel
32 Central flow channel wall
33 Hole
34 Slit
40 Catalyst-supported wire
40a End portion
41 Electric heating wire
42 Catalyst layer

1. A reactor, comprising:
a cylindrical reaction vessel disposed in an upright position, and
a reaction region inside of the reaction vessel, in which a chemical reaction is performed;
wherein the reaction region has a catalyst member, having a heating part generating heat by being energized and a catalyst disposed to be heated by the heating part, which is concentrically disposed in a cross-section perpendicular to an axial direction of the reaction vessel;
wherein the reaction vessel comprises:
an outer flow channel which is formed on an outer side relative to the reaction region in a cross-section perpendicular to the axial direction of the reaction vessel and which is communicated with an outside of the reaction vessel,
a central flow channel which is formed on a center side relative to the reaction region in a cross-section perpendicular to the axial direction of the reaction vessel and which is communicated with an outside of the reaction vessel,
an outer flow channel wall separating the reaction region and the outer flow channel, through which fluid can pass, and
a central flow channel wall separating the reaction region and the central flow channel, through which fluid can pass, and
wherein the catalyst member is formed of a catalyst-supported wire, which has a wire-shaped electric heating wire as the heating part and a catalyst layer containing the catalyst and disposed on a surface of the electric heating wire.

2. (canceled)

3. The reactor according to claim 1,
wherein the catalyst-supported wire is wound in a helical or mesh configuration.

4. The reactor according to claim 1,
wherein the catalyst layer has a carrier and a catalyst supported by the carrier.

5. The reactor according to claim 4,
wherein the carrier is γ-alumina.

6. The reactor according to claim 1,
wherein the catalyst is ruthenium or nickel.

7. The reactor according to claim 1,
wherein the reaction region has a plurality of the catalyst members which are concentrically disposed in a cross-section perpendicular to the axial direction of the reaction vessel.

8. The reactor according to claim 7,
wherein amounts of current passing through the plurality of catalyst members each can be independently controlled.

9. The reactor according to claim 1,
wherein a hole or slit through which the fluid can pass is formed on the outer flow channel wall.

10. The reactor according to any claim 1,
wherein a hole or slit through which the fluid can pass is formed on the central flow channel wall.

11. The reactor according to claim 1,
wherein the reactor is used to perform an ammonia decomposition reaction.

12. A method for producing an ammonia decomposition mixture by a decomposition reaction of ammonia using the reactor according to claim 11, comprising:
introducing ammonia from the central flow channel into the reaction region,
energizing the heating part to heat the catalyst,
performing a decomposition reaction of ammonia in the reaction region to produce an ammonia decomposition mixture, and
discharging the ammonia decomposition mixture from the reaction region to the outer flow channel.

13. The method for producing an ammonia decomposition mixture according to claim 12,
wherein a temperature of the heating part is from 350 to 700° C.

14. The method for producing an ammonia decomposition mixture according to claim 12,
wherein a pressure of the reaction region is from 0 to 0.9 MPaG.
